(19) United States
(12) Patent Application Publication
(10) Pub. No.: US 2009/0066457 A1
(43) Pub. Date: Mar. 12, 2009

(54) ELECTRONIC DEVICE HAVING TRANSFORMER

(75) Inventor: Shinichi UCHIDA, Kawasaki (JP)

Correspondence Address: YOUNG & THOMPSON, 209 Madison Street, Suite 500, ALEXANDRIA, VA, 22314, US

(73) Assignee: NEC ELECTRONICS CORPORATION, KAWASAKI (JP)

(21) Appl. No.: 12/206,262

(22) Filed: Sep. 8, 2008

(30) Foreign Application Priority Data
Sep. 6, 2007 (JP) 2007/231564

(51) Int. Cl. H01F 27/28

(52) U.S. Cl. 336/188

(57) ABSTRACT

An electronic device includes a first inductor which is symmetrical with respect to a first line in plan view and a second inductor having the same shape as that of the first inductor. The first inductor and the second inductor are disposed so as to be symmetrical with each other with respect to a second line which is orthogonal to the first line. The first inductor and the second inductor are disposed so as to intersect on the second line in plan view.

### BACKGROUND OF THE INVENTION

1. Field of the Invention

The present invention relates to an electronic device, and more particularly, to an electronic device including a transformer.

2. Description of the Related Art

Jianjun J. Zhou et. al., “Monolithic Transformers and Their Application in a Differential CMOS RF Low-Noise Amplifier,” IEEE Journal of Solid State Circuits, Vol. 33, No. 12 (December 1998), pp. 2020-2027 describes a layout of a transformer including two identical spiral conductors (inductors). Here, the transformer is used for a differential circuit.

Ouail El-Gharniti et. al., “Modeling of Integrated Monolithic Transformers for Silicon RF IC,” Electronics, Circuits and Systems, 2004, ICECS 2004. Proceedings of the 2004 11th IEEE International Conference on, 13-15 Dec. 2004, pp. 137-140 describes a layout of a transformer formed on silicon. FIG. 10 illustrates the layout of the transformer described therein. A transformer 10 includes two inductors 12 and 14.

JP 2005-509300 A, JP 11-54705 A, and JP 2000-124403 A describe structures of an inductor formed on a base or a substrate.

However, the transformers described in the above-mentioned documents have a problem in that, due to inferior symmetry of the layout, symmetry of impedance of the transformers is degraded, and their characteristics are deteriorated when used for a differential circuit or used as a balun. For example, in the structure described in Jianjun J. Zhou et. al., with regard to each spiral conductor forming the transformer, one end thereof is located inside a spiral shape while the other end thereof is located outside the spiral shape. The structure is asymmetrical and the structure seen from the side of the one end is different from the structure seen from the side of the other end. In the structure described in Ouail El-Gharniti et al., the two inductors forming the transformer have different shapes. The structure is asymmetrical and the structure seen from an end of one inductor and the structure seen from an end of the other inductor are different. JP 2005-509300 A, JP 11-54705 A, and JP 2000-124403 A do not describe a transformer having a symmetrical structure.

### SUMMARY OF THE INVENTION

The present invention provides an electronic device including: a substrate; and a transformer formed on the substrate and including a first inductor and a second inductor, the first inductor being symmetrical with respect to a first line in plan view, the second inductor having the same shape as that of the first inductor, the first inductor and the second inductor being disposed so as to be symmetrical with each other with respect to a second line which is orthogonal to the first line.

By designing the layout of the transformer in this way, the structure of the transformer can be made to be vertically and horizontally symmetrical. This makes it possible to make the impedance the same when seen from any of input ends and output ends of the inductors forming the transformer, and thus, the electrical characteristics of the transformer can be made satisfactorily symmetrical. Therefore, satisfactory characteristics can be obtained when the transformer is used for a differential circuit or used as a balun.

It is to be noted that any arbitrary combination of the above-described components and any change in expression of the present invention between a method, an apparatus, a system, a recording medium, a computer program, and so forth are all effective as embodiments of the present invention.

According to the present invention, symmetry of impedance of a transformer can be improved and characteristics thereof can be made satisfactory.

### BRIEF DESCRIPTION OF THE DRAWINGS

In the accompanying drawings:

FIG. 1 is a schematic view illustrating a structure of an electronic device according to an embodiment of the present invention;

FIGS. 2A to 2C describe a shape of a first loop-like conductor of a first inductor illustrated in FIG. 1;

FIGS. 3A to 3C describe the shape of the first loop-like conductor of the first inductor illustrated in FIG. 1;

FIG. 4 is a plan view of a transformer illustrated in FIG. 1;

FIGS. 5A to 5C illustrate an example of sections of the transformer illustrated in FIG. 4;

FIGS. 6A to 6C illustrate another example of sections of the transformer illustrated in FIG. 4;

FIG. 7 is a plan view illustrating another exemplary transformer according to the embodiment of the present invention;

FIG. 8 is a plan view illustrating still another exemplary transformer according to the embodiment of the present invention;

FIG. 9 is a plan view illustrating yet another exemplary transformer according to the embodiment of the present invention; and

FIG. 10 illustrates a layout of a conventional transformer.

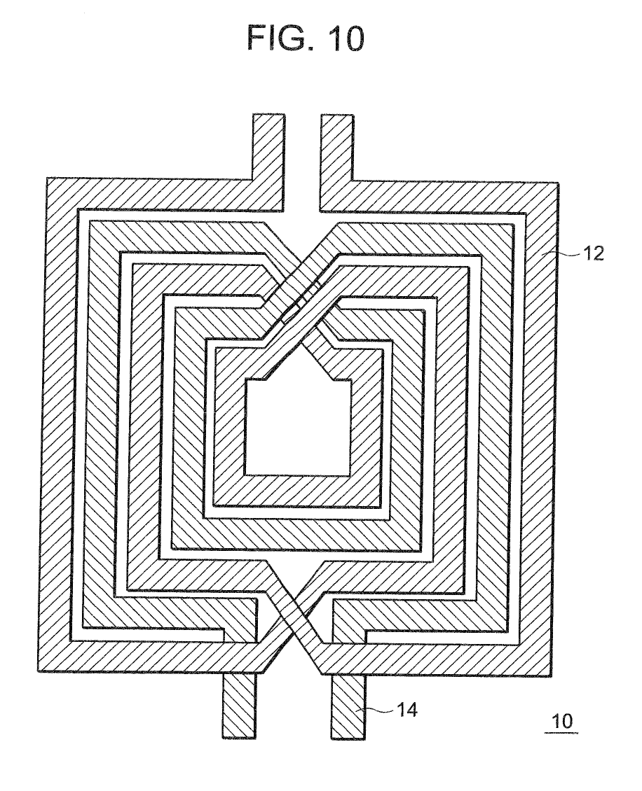

### DETAILED DESCRIPTION OF THE PREFERRED EMBODIMENT

An embodiment of the present invention are now described in the following with reference to the attached drawings. It is to be noted that, throughout the drawings, like reference numerals denote like components and description thereof is omitted as appropriate.

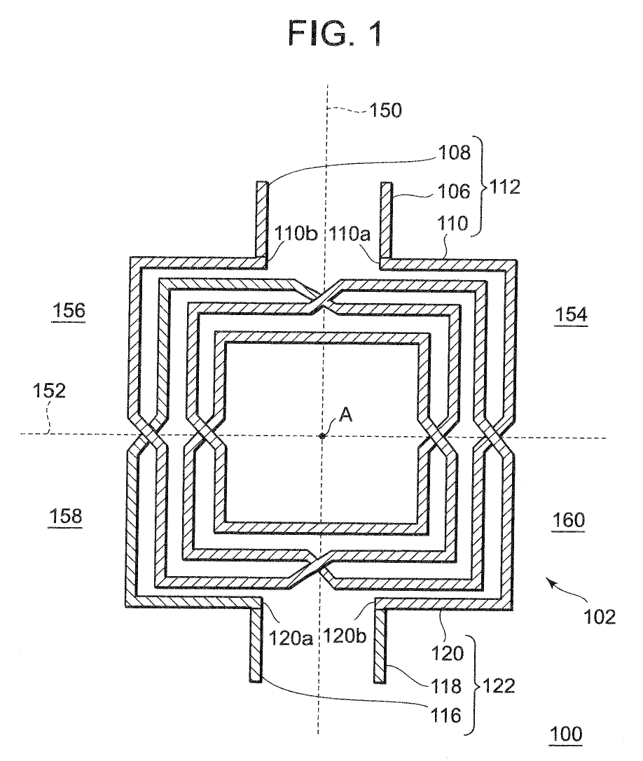

FIG. 1 is a schematic view of a structure of an electronic device 100 according to the present embodiment.

The electronic device 100 includes a substrate (not shown) and a transformer 102 formed on the substrate. The transformer 102 includes a first inductor 112 and a second inductor 122. The first inductor 112 is symmetrical with respect to a first line 150 in plan view. The second inductor 122 has the same shape as that of the first inductor 112, and is also symmetrical with respect to the first line 150 in plan view. The first inductor 112 and the second inductor 122 are disposed so as to be symmetrical with each other with respect to a second line 152 which is orthogonal to the first line 150. Both the first inductor 112 and the second inductor 122 are wound a plurality of times, that is, twice or more. In the present embodiment, the inductor is wound twice.

Next, a specific shape of the transformer 102 is described.

Here, in the description, a plane on the substrate is divided by the first line 150 and the second line 152 into a first area 154, a second area 156, a third area 158, and a fourth area 160. The second area 156 is an area which is symmetrical with the first area 154 with respect to the first line 150. The third area 158 is an area which is symmetrical with the second area 156 with respect to the second line 152. The fourth area 160 is an area which is symmetrical with the third area 158 with respect to the first line 150. More specifically, in the figure, when the upper right area of the plane defined by the first line 150 and the second line 152 is the first area 154, the upper left area is the second area 156, the lower left area is the third area 158, and the lower right area is the fourth area 160. The first line 150 and the second line 152 intersect at an intersection A.

The first inductor 112 includes a first loop-like conductor 110, a first terminal 106, and a second terminal 108. In plan view, the first loop-like conductor 110 has its starting point 110a in the first area 154, is wound so as to surround the intersection A across the second line 152 and the first line 150, and has its ending point 110b in the second area 156. The first terminal 106 is connected to the starting point 110a of the first loop-like conductor 110, and the second terminal 108 is connected to the ending point 110b of the first loop-like conductor 110. The first terminal 106 is disposed in the first area 154 while the second terminal 108 is disposed in the second area 156. In the present embodiment, the first terminal 106 and the second terminal 108 are disposed substantially in parallel with the first line 150 at a predetermined distance from the first line 150. Further, the first terminal 106 and the second terminal 108 are disposed so as to be symmetrical with each other with respect to the first line 150.

In the present embodiment, the first loop-like conductor 110 is wound such that its diameter becomes smaller when the first loop-like conductor 110 beginning from the starting point 110a goes across the second line 152, the first loop-like conductor 110 goes across the first line 150 once with the diameter being maintained, and then, the diameter becomes larger when the first loop-like conductor 110 goes across the second line 152. In the present embodiment, the first loop-like conductor 110 is in the shape of a rectangle in plan view. In the present embodiment, the first loop-like conductor 110 is wound such that, before the first loop-like conductor 110 goes across the first line 150 once with the diameter being maintained as described above, the diameter also becomes smaller when the first loop-like conductor 110 goes across the first line 150, and, after the first loop-like conductor 110 goes across the first line 150 once with the diameter being maintained as described above, the diameter also becomes larger when the first loop-like conductor 110 goes across the first line 150.

More specifically, the first loop-like conductor 110 is wound such that the diameter becomes smaller every time the first loop-like conductor 110 goes across the second line 152 and the first line 150, and, after the first loop-like conductor 110 goes across the second line 152 and the first line 150 in turn N times (N is an odd number equal to or larger than 3) and is wound inward, the first loop-like conductor 110 goes across the first line 150 once with the diameter being maintained. Then, the first loop-like conductor 110 is wound such that the diameter becomes larger every time the first loop-like conductor 110 goes across the second line 152 and the first line 150, and, the first loop-like conductor 110 goes across the second line 152 and the first line 150 in turn N times and is wound outward. When the first loop-like conductor 110 is wound outward and goes across the first line 150, the first loop-like conductor 110 has a pattern where the first loop-like conductor 110 intersects a part of the first loop-like conductor which is wound inward. FIG. 1 illustrates a case where N=3. Here, the first loop-like conductor 110 is wound twice.

The second inductor 122 has the same shape as that of the first inductor 112. The second inductor 122 is disposed so as to be symmetrical with the first inductor 112 with respect to the second line 152. More specifically, the second inductor 122 includes a second loop-like conductor 120, a third terminal 116, and a fourth terminal 118. In plan view, the second loop-like conductor 120 has its starting point 120a in the third area 158, has its ending point 120b in the fourth area 160, and has the same shape as that of the first loop-like conductor 110. The third terminal 116 is connected to the starting point 120a of the second loop-like conductor 120, and the fourth terminal 118 is connected to the ending point 120b of the second loop-like conductor 120. The third terminal 116 is disposed in the third area 158 while the fourth terminal 118 is disposed in the fourth area 160. In the present embodiment, the third terminal 116 and the fourth terminal 118 are disposed substantially in parallel with the first line 150 at a predetermined distance from the first line 150. The third terminal 116 and the fourth terminal 118 are disposed so as to be symmetrical with each other with respect to the first line 150.

The first loop-like conductor 110 of the first inductor 112 and the second loop-like conductor 120 of the second inductor 122 are disposed so as to intersect on the second line 152 in plan view. Further, the first loop-like conductor 110 and the second loop-like conductor 120 are disposed so as to, at any portion thereof, run side by side whether the second loop-like conductor 120 is disposed inside or outside the first loop-like conductor 110. In this way, the function of the transformer 102 can be materialized.

As described above, in the present embodiment, the transformer 102 is formed by two identical inductors which are, in plan view, each symmetrical with respect to the first line 150, and which are disposed so as to be symmetrical with each other with respect to the second line 152. This can make it possible to make the structure of the transformer 102 vertically and horizontally symmetrical. Such a structure can be materialized by forming the first loop-like conductor 110 of the first inductor 112 and the second loop-like conductor 120 of the second inductor 122 in a pattern where the two conductors intersect on the second line 152. Further, by winding inward each of the first loop-like conductor 110 and the second loop-like conductor 120, turning around on the inside, and then winding outward such that the portion which is wound inward and the portion which is wound outward intersect on the first line 150, the first loop-like conductor 110 and the second loop-like conductor 120 can have a structure where they are each wound a plurality of times.

The above-mentioned structure makes it possible to make impedance the same when seen from any of input ends and output ends of the inductors (first inductor 112 and second inductor 122) forming the transformer 102, and thus, the electrical characteristics of the transformer 102 can be made satisfactorily symmetrical. Therefore, satisfactory characteristics can be obtained when the transformer 102 is used for a differential circuit or used as a balun.

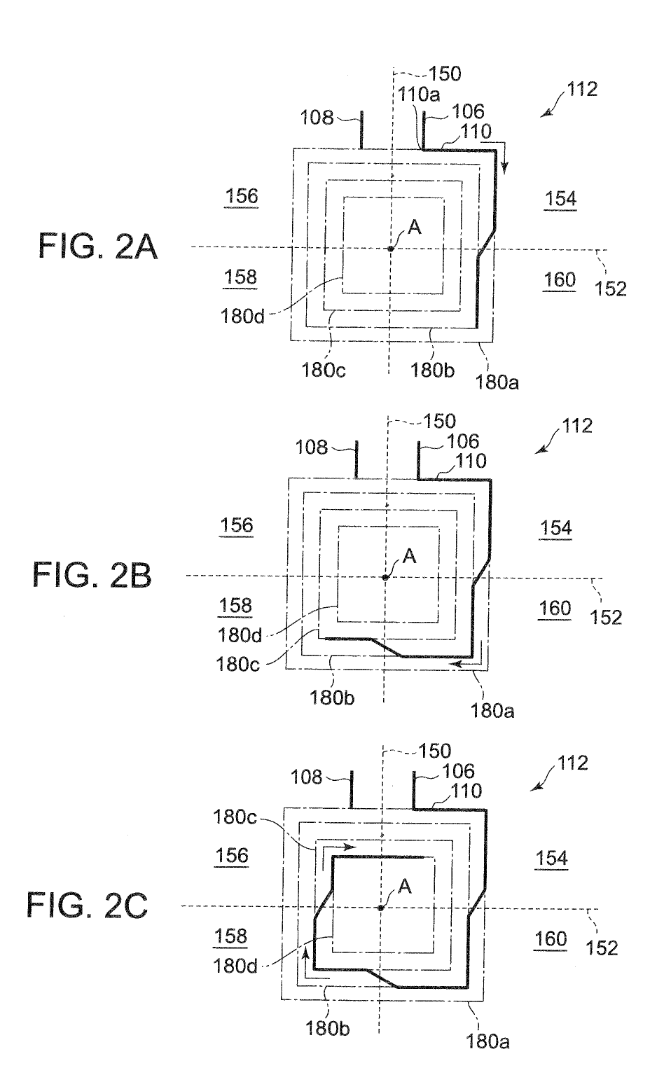

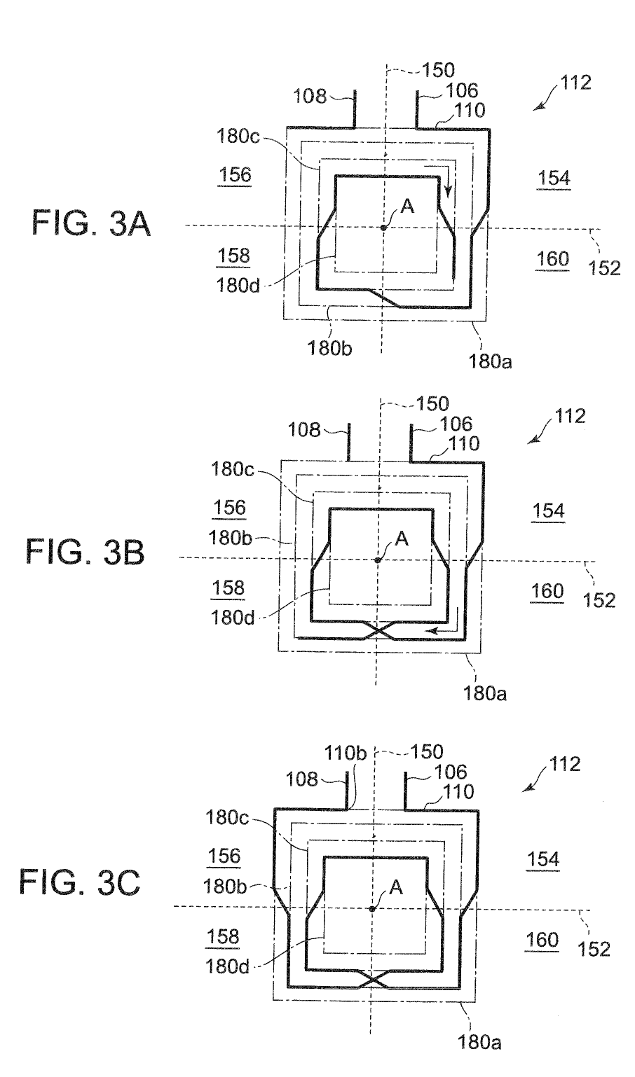

Next, FIGS. 2A to 3C are used to describe the shape of the first loop-like conductor 110.

Here, a first square 180a, a second square 180b, a third square 180c, and a fourth square 180d the center of all of which is the intersection A of the first line 150 and the second line 152 are used as auxiliary lines. The first square 180a, the second square 180b, the third square 180c, and the fourth square 180d are in decreasing order of diameter and they are disposed at substantially equal spacings.

The starting point 110a of the first loop-like conductor 110 and the first terminal 106 are connected on the first square 180a. The first loop-like conductor 110 extends rightward in the figure from a connecting point (110a) with the first terminal 106 along the first square 180a, turns substantially vertically downward in the figure at a corner of the first square 180a and then extends downward. Here, when the first loop-like conductor 110 goes across the second line 152, the first loop-like conductor 110 moves onto the second square 180b inside the first square 180a and extends downward along the second square 180b (FIG. 2A). Then, the first loop-like conductor 110 turns substantially vertically leftward in the figure at a corner of the second square 180b and extends leftward. Here, when the first loop-like conductor 110 goes across the first line 150, the first loop-like conductor 110 moves onto the third square 180c inside the second square 180b and extends leftward along the third square 180c (FIG. 2B).

Then, the first loop-like conductor 110 turns substantially vertically upward in the figure at a corner of the third square 180c and extends upward. Here, when the first loop-like conductor 110 goes across the second line 152, the first loop-like conductor 110 moves onto the fourth square 180d inside the third square 180c and extends upward along the fourth square 180d. In the above, the first loop-like conductor 110 is wound inward such that the diameter gradually becomes smaller. Further, the first loop-like conductor 110 turns substantially vertically rightward in the figure at a corner of the fourth square 180d and extends rightward. Here, when the first loop-like conductor 110 goes across the first line 150, the first loop-like conductor 110 extends along the fourth square 180d and maintains the diameter (FIG. 2C).

After this, the first loop-like conductor 110 is wound outward such that the diameter gradually becomes larger. The first loop-like conductor 110 turns substantially vertically downward in the figure at a corner of the fourth square 180d and extends downward. Here, when the first loop-like conductor 110 goes across the second line 152, the first loop-like conductor 110 moves onto the third square 180c outside the fourth square 180d and extends downward along the third square 180c (FIG. 3A). Then, the first loop-like conductor 110 turns substantially vertically leftward in the figure at a corner of the third square 180c and extends leftward. Here, when the first loop-like conductor 110 goes across the first line 150, the first loop-like conductor 110 moves onto the second square 180b outside the third square 180c and extends leftward along the second square 180b. It is to be noted that the first loop-like conductor 110 intersects itself which is wound inward on the first line 150 (FIG. 3B).

Then, the first loop-like conductor 110 turns substantially vertically upward in the figure at a corner of the second square 180b and extends upward. Here, when the first loop-like conductor 110 goes across the second line 152, the first loop-like conductor 110 moves onto the first square 180a outside the second square 180b and extends upward along the first square 180a. Further, the first loop-like conductor 110 turns substantially vertically rightward in the figure at a corner of the first square 180a, extends rightward, and is connected to the second terminal 108 on the first square 180a (FIG. 3C).

Next, the space structure of the transformer 102 is described.

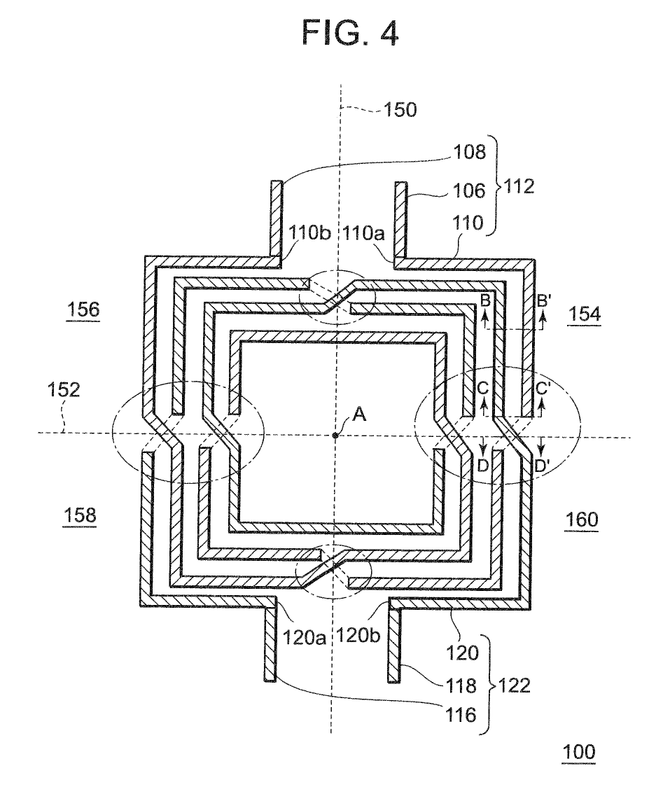

FIG. 4 is a plan view of the transformer 102. In the present embodiment, the transformer 102 has a multilayer wiring structure formed on the substrate. Intersections of the transformer 102 are materialized by wiring formed in different layers. Here, wiring formed in a lower layer at the intersections (portions surrounded by alternate long and short dash lines in the figure) is indicated by broken lines.

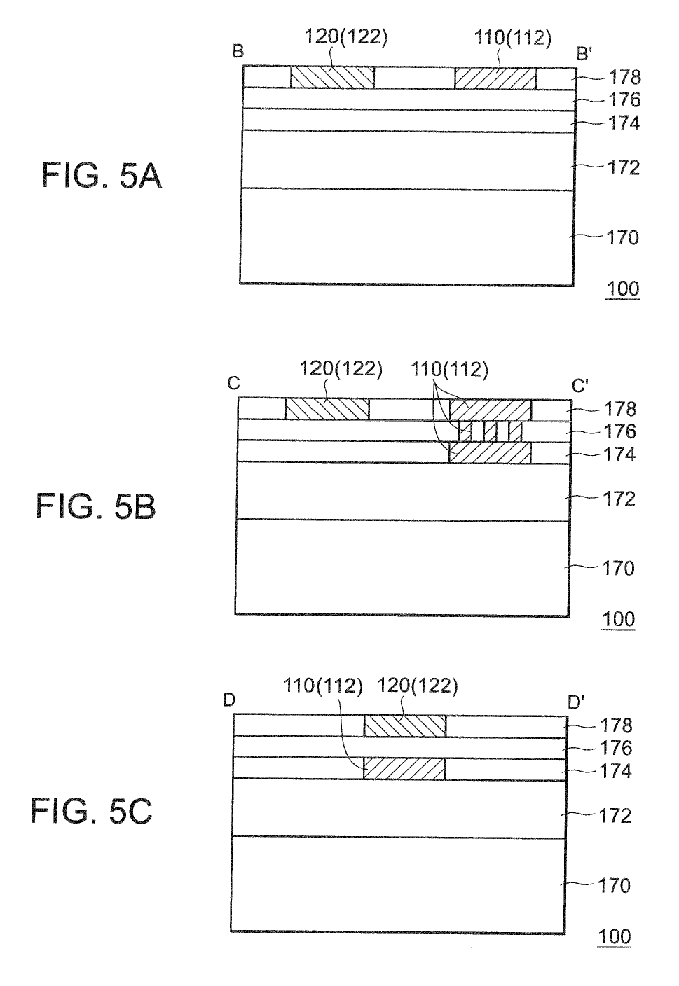

FIG. 5 illustrates an example of sections of FIG. 4. FIG. 5A is a sectional view taken along the line B-B′ of FIG. 4, FIG. 5B is a sectional view taken along the line C-C′ of FIG. 4, and FIG. 5C is a sectional view taken along the line D-D′ of FIG. 4.

The electronic device 100 includes a substrate 170, an insulating film 172, an insulating film 174 for lower layer wiring, an insulating film 176 for vias, and an insulating film 178 for upper layer wiring. The insulating film 172, the insulating film 174 for lower layer wiring, the insulating film 176 for vias, and the insulating film 178 for upper layer wiring are formed on the substrate 170 in this order. The substrate 170 can be, for example, a semiconductor substrate such as a silicon substrate or a glass substrate.

Here, both the first inductor 112 and the second inductor 122 except for the intersections are formed by wiring formed in the insulating film 178 for upper layer wiring. More specifically, portions indicated by solid lines in FIG. 4 of the first inductor 112 and the second inductor 122 are also formed by wiring formed in the insulating film 178 for upper layer wiring (FIG. 5A).

On the other hand, the intersections indicated by broken lines in FIG. 4 are formed by wiring formed in the insulating film 174 for lower layer wiring. It is to be noted that the wiring formed in the insulating film 178 for upper layer wiring and the wiring formed in the insulating film 174 for lower layer wiring are electrically connected through vias formed in the insulating film 176 for vias (FIG. 5B and FIG. 5C).

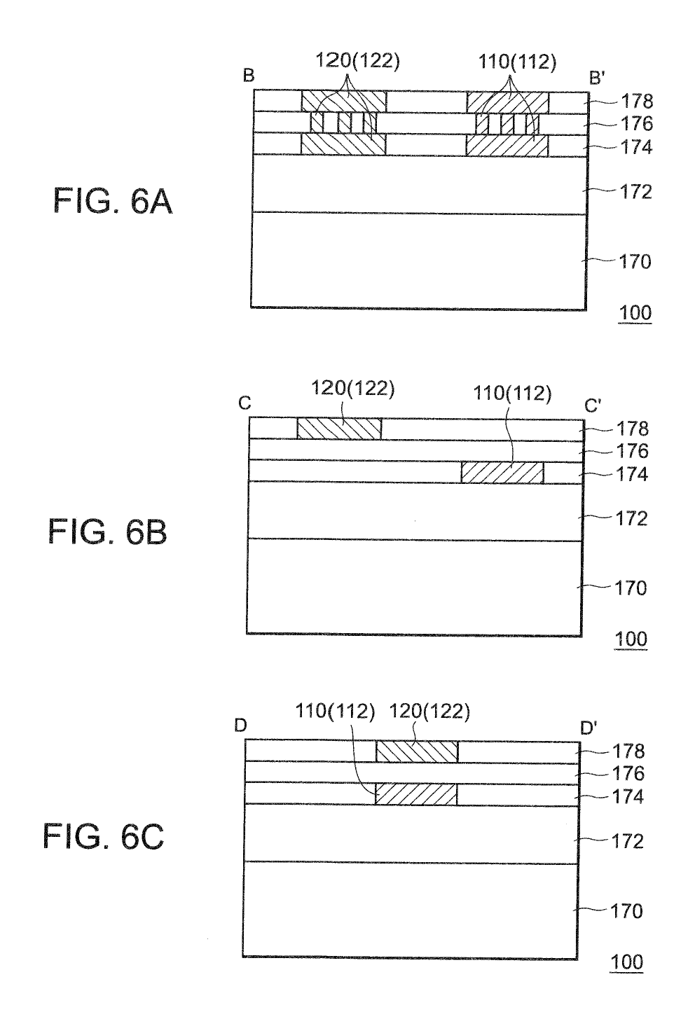

FIG. 6 illustrates another example of sections of FIG. 4. FIG. 6A is a sectional view taken along the line B-B′ of FIG. 4, FIG. 6B is a sectional view taken along the line C-C′ of FIG. 4, and FIG. 6C is a sectional view taken along the line D-D′ of FIG. 4.

Here, both the first inductor 112 and the second inductor 122 except for the intersections are formed by the wiring formed in the insulating film 174 for lower layer wiring, the vias formed in the insulating film 176 for vias, and the wiring formed in the insulating film 178 for upper layer wiring. More specifically, both the first inductor 112 and the second inductor 122 except for the intersections indicated in FIG. 4 are formed so as to have a three-layer structure including the wiring formed in the insulating film 174 for lower layer wiring, the vias formed in the insulating film 176 for vias, and the wiring formed in the insulating film 178 for upper layer wiring (FIG. 6A).

On the other hand, the intersections of the first inductor 112 and the second inductor 122 are formed by any one of the wiring formed in the insulating film 174 for lower layer wiring and the wiring formed in the insulating film 178 for upper layer wiring. The portions of the intersections indicated by broken lines in FIG. 4 are formed by the wiring formed in the insulating film 174 for lower layer wiring while the portions of the intersections indicated by solid lines are formed by the wiring formed in the insulating film 178 for upper layer wiring (FIG. 6B and FIG. 6C).

It is to be noted that, with regard to both the case illustrated in FIGS. 5A to 5C and the case illustrated in FIGS. 6A to 6C, the wiring and the vies can be formed simultaneously with other wiring in the multilayer wiring structure Further, the wiring and the vies can be formed using, for example, copper or aluminum. When the wiring and the vias are formed using copper, the damascene process, for example, can be used.

Further, in the present embodiment, the transformer 102 can be formed in various shapes.

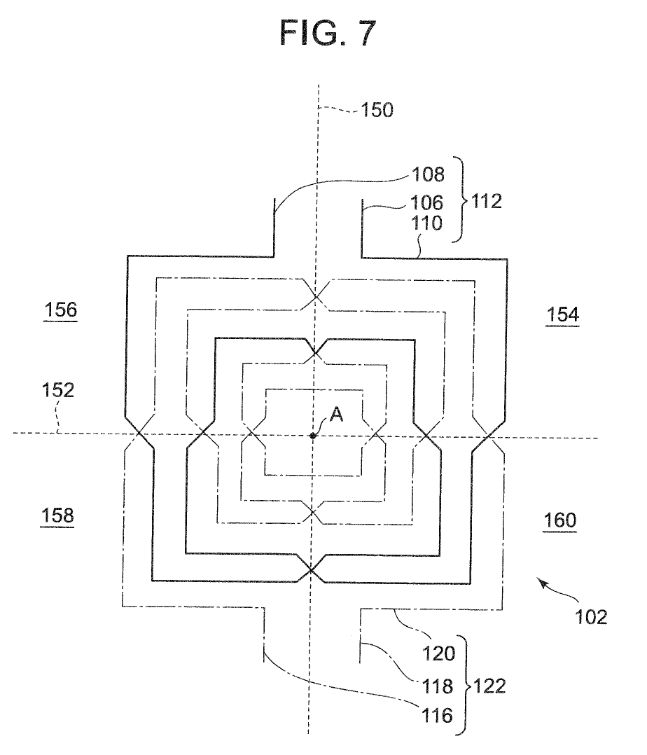

For example, the number of turns of the first loop-like conductor 110 can be increased. While FIG. 1 illustrates a case where the number of turns N of the first loop-like conductor 110 goes across the second line 152 and the first line 150 equals three and the first loop-like conductor 110 is wound twice when the first loop-like conductor 110 is wound inward and outside, FIG. 7 is a plan view of a transformer when N=5 and the first loop-like conductor 110 is wound three times. Although, in the following, for the sake of simplicity, the first inductor 112 and the second inductor 122 are indicated by lines, they are formed by wiring and the like similarly to the case illustrated in FIG. 1.

Here, the first loop-like conductor 110 is wound such that the diameter becomes smaller every time the first loop-like conductor 110 goes across the second line 152 and the first line 150. After the first loop-like conductor 110 goes across the second line 152 and the first line 150 in turn five times and is wound inward, the first loop-like conductor 110 goes across the first line 150 once with the diameter being maintained. Then, the first loop-like conductor 110 is wound such that the diameter becomes larger every time the first loop-like conductor 110 goes across the second line 152 and the first line 150, goes across the second line 152 and the first line 150 in turn five times, and is wound outward. The second loop-like conductor 120 has the same shape as that of the first loop-like conductor 110.

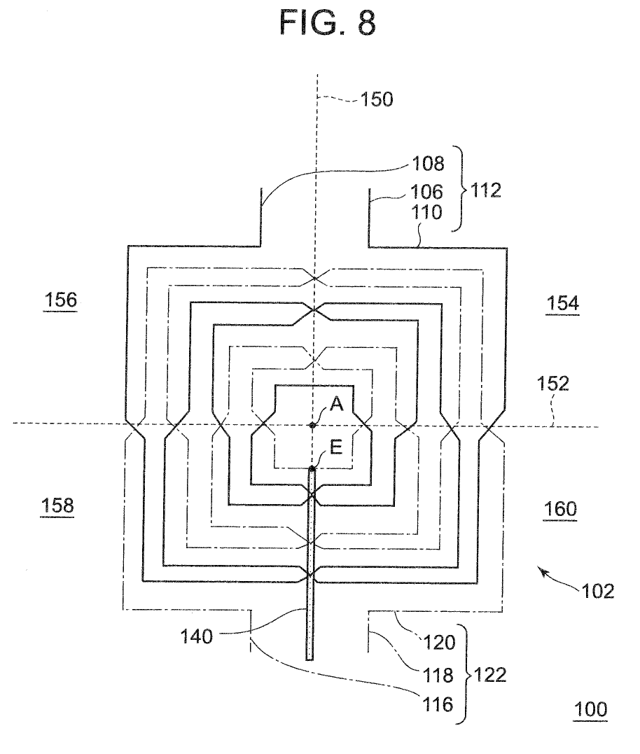

Similarly, FIG. 8 is a plan view of a transformer when N=7 and the first loop-like conductor 110 is wound four times. Further, here, the electronic device 100 includes a center tap 140. In the center tap 140, a portion E where the second loop-like conductor 120 goes across the first line 150 once with its diameter being maintained is a connecting point with the second loop-like conductor 120. In plan view, the center tap 140 extends from the connecting point E along the first line 150 to a position between the starting point and the ending point of the second loop-like conductor 120. In the present embodiment, the center tap 140 can be disposed so as to extend between and substantially in parallel with the third terminal 116 and the fourth terminal 118. This makes it possible to materialize the electronic device 100 having the center tap 140 with the transformer 102 being kept satisfactorily symmetrical.

It is to be noted that structures other than the one illustrated in FIG. 8 can, similarly, have the center tap 140 combined therewith.

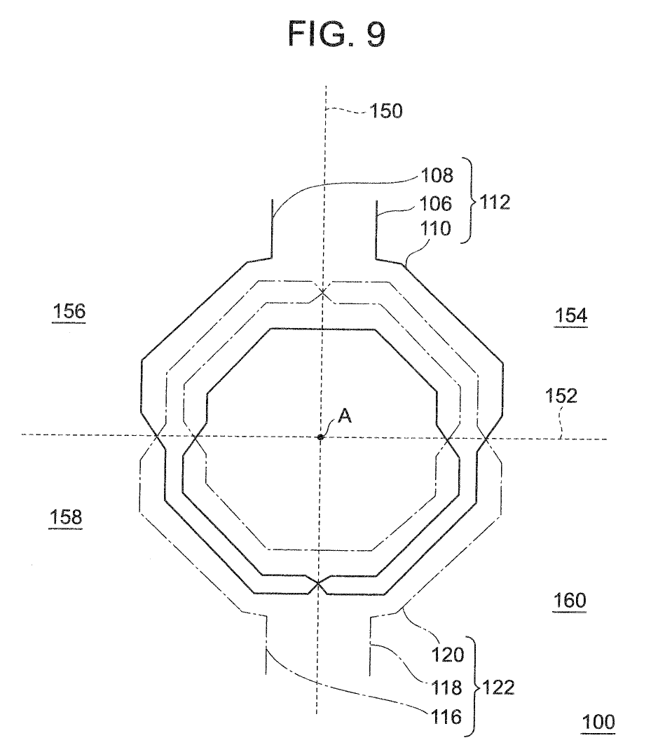

Further, the loop-like conductors of the inductors can be in various shapes. FIG. 9 is a plan view illustrating a case where the first loop-like conductor 110 and the second loop-like conductor 120 are octagonal in plan view. Here, a transformer where N=3 and the loop-like conductors are wound twice is illustrated. In this way, even if the shape in plan view of the first loop-like conductor 110 and the second loop-like conductor 120 is varied according to a pattern disposed around them and the like, by determining their pattern according to a rule similar to the one described with reference to FIGS. 1 to 4, similar effects can be obtained. Further, the first loop-like conductor 110 and the second loop-like conductor 120 can be, for example, circular in plan view (not shown).

Although the embodiment of the present invention is described above with reference to the drawings, it is merely exemplary and various other variations and modifications are possible which fall within the scope of the present invention.

What is claimed is:

1. An electronic device comprising:
a substrate; and
a transformer formed on the substrate and including a first inductor and a second inductor, the first inductor being symmetrical with respect to a first line in plan view, the second inductor having the same shape as that of the first inductor, the first inductor and the second inductor being disposed so as to be symmetrical with each other with respect to a second line which is orthogonal to the first line.

2. An electronic device according to claim 1, wherein
the first inductor and the second inductor are wound twice or more.

3. An electronic device according to claim 1, wherein:
the first inductor includes a first loop-like conductor having a starting point in a first area defined by the first line and the second line in plan view, being wound by going across the second line and the first line in turn with an intersection of the first line and the second line being a center, and having an ending point in a second area which is symmetrical with the first area with respect to the first line;
the first loop-like conductor is wound such that a diameter of the first loop-like conductor becomes smaller when the first loop-like conductor beginning from the starting point goes across the second line, the first loop-like conductor goes across the first line once with the diameter being maintained, and then, the diameter becomes larger when the first loop-like conductor goes across the second line;
the second inductor includes a second loop-like conductor having the same shape as that of the first loop-like conductor, the second loop-like conductor having a starting point in a third area which is symmetrical with the second area with respect to the second line, and having an ending point in a fourth area which is symmetrical with the first area with respect to the second line; and
the first loop-like conductor and the second loop-like conductor are disposed so as to intersect on the second line in plan view.

4. An electronic device according to claim 3, wherein
the first loop-like conductor is wound such that the diameter becomes smaller every time the first loop-like conductor goes across the second line and the first line, and, after the first loop-like conductor goes across the second line and the first line in turn N times, where N is an odd number which is equal to or larger than 3, and is wound inward, the first loop-like conductor goes across the first line once with the diameter being maintained, and then, the first loop-like conductor is wound such that the diameter becomes larger every time the first loop-like conductor goes across the second line and the first line, and, the first loop-like conductor goes across the second line and the first line in turn N times and is wound outward so as to intersect a portion of the first loop-like conductor which is wound inward when the first loop-like conductor goes across the first line.

5. An electronic device according to claim 3, further comprising
a center tap having a connecting point with the second loop-like conductor in a portion of the second loop-like conductor which goes across the first line once with a diameter of the second loop-like conductor being maintained, the center tap extending, in plan view, from the connecting point along the first line to a position between the starting point and the ending point of the second loop-like conductor.

6. An electronic device according to claim 4 further comprising:
a center tap having a connecting point with the second loop-like conductor in a portion of the second loop-like conductor which goes across the first line once with a diameter of the second loop-like conductor being maintained, the center tap extending, in plan view, from the connecting point along the first line to a position between the starting point and -the ending point of the second loop-like conductor.
